(19) United States
(12) Patent Application Publication
(10) Pub. No.: US 2021/0293516 A1
(43) Pub. Date: Sep. 23, 2021

(54) REMOTELY CONTROLLED PROPERTY SECURITY DEVICE AND SYSTEM

(71) Applicant: Leviasec Corporation, Dallas, TX (US)

(72) Inventor: Pierre Alkubeh, Dallas, TX (US)

(21) Appl. No.: 16/821,047

(22) Filed: Mar. 17, 2020

(51) Int. Cl. F41H 9/04; F41B 11/71; A62C 37/40; H04N 7/18

(52) U.S. Cl. CPC F41H 9/04; F41B 11/71; G06F 3/0488; H04N 7/183; A62C 37/40

(57) ABSTRACT

A safety device configured to fire projectiles. The safety device includes a firing mechanism, a y-axis frame, an x-axis frame, a first control unit, a camera, and a monitoring control unit. The y-axis frame having a first actuator and the x-axis frame having a second actuator. The monitoring unit having a second control unit, wherein the second control unit is in communication with the first control unit. The safety device capturing imaging and transmitting imaging to the monitoring unit. The monitoring unit generating a display. The second control unit tracking a target on the display and calculating angle coordinates. The second control unit communicating the angle coordinates to the first control unit. The first control unit generating firing coordinates and transmitting the firing coordinates to the first actuator and the second actuator. The first actuator and the second actuator adjusting the firing mechanism position to correspond to the firing coordinates.

### BACKGROUND OF THE INVENTION

### Technical Field

The present disclosure relates to a method and system for monitoring the security and safety of an area.

### Description of Related Art

Residential and commercial security systems are commonly used to protect people and property from intruders. Security systems commonly utilize alarms and alerts to authorities to protect against intruders. Additionally, security systems may be equipped to detect other harmful situations such as a fire or carbon monoxide leak. However, security systems may be a cost-prohibitive solution for individuals or business owners. Furthermore, a security system may not provide a sufficient deterrent to intruders.

Alternatively, individuals may utilize weapons such as firearms or stun guns to protect against intruders and fire extinguishers to combat fires. However, individuals may be uncomfortable using lethal force or not properly trained to use a firearm. Moreover, the use of firearms and non-lethal force (e.g., stun gun) requires an individual to physically confront an intruder. Similarly, the use of a fire extinguisher or similar means require an individual to be physically confront an unsafe situation. Currently, there are automated weapon systems that enable to an individual to remotely operate a firearm.

However, such weapon systems are not designed to provide non-lethal protection in civilian settings. In contrast, these weapons systems are designed to operate heavy weaponry in offensive combat situations. Furthermore, these weapon systems are not adaptable to provide lawful protection in a civilian setting. Such systems are designed to automatically fire at all detected object once permission is given. In addition to the different nature of use, these systems are designed for larger environments and must account for larger distances and heavier equipment that would be more complicated and unnecessary for a civilian.

Therefore, there is a need for providing an improved remote controlled security system that is capable of non-lethal force and fire extinguishing capabilities. Additionally, there is a need for a more simplistic and practical security system.

### SUMMARY OF THE INVENTION

The present disclosure relates to a safety device which may be configured to fire projectiles. The safety device includes a firing mechanism, a y-axis frame, an x-axis frame, and a camera. The y-axis frame configured to include a first actuator and a trigger actuator. The x-axis frame configured to include a second actuator, a mounting base, and a first control unit. The first control unit comprises a first access point. The mounting base is configured to attach the safety device to the surface of a structure.

The present disclosure also relates to a method for operating a safety system, wherein a safety device captures imaging and transmits the imaging to a monitoring device. The monitoring device may be configured to generate a display, wherein the display includes the imaging and sets of commands. Additionally, the monitoring unit may be configured to target a specific object in the imaging and track the position of the target.

Other embodiments of the present disclosure involve a safety system. In one embodiment, the system comprises a safety device and a monitoring device. The safety device configured to include a firing mechanism, a first control unit, a first actuator, a second actuator, a trigger actuator, and a camera. The first control unit includes a first access point. The monitoring device includes a second control unit and a user interface. The second control unit is configured to communicate with the user interface. The second control unit includes a second access point, wherein the second access point is in communication with the first access point. In various embodiments, the second access point and the first access point are in wired or wireless communication.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a first side perspective view of a safety device.

FIG. 2 is a second side perspective view of a safety device.

FIG. 3 is a front perspective view of a safety device.

FIGS. 4A-4C illustrate an embodiment of the cartridge and projectiles.

FIGS. 5A and 5B illustrate an embodiment of the graphic user interface.

FIG. 6 is a diagram of one embodiment of a method to operate the safety system.

FIG. 7 is a diagram illustrating an embodiment of the safety system.

FIGS. 8A-8E are block diagrams illustrating an embodiment of the safety system.

### DETAILED DESCRIPTION

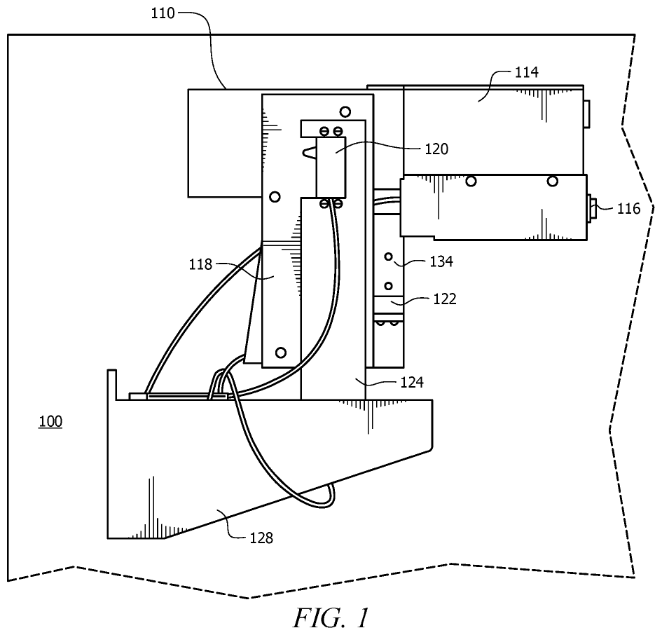

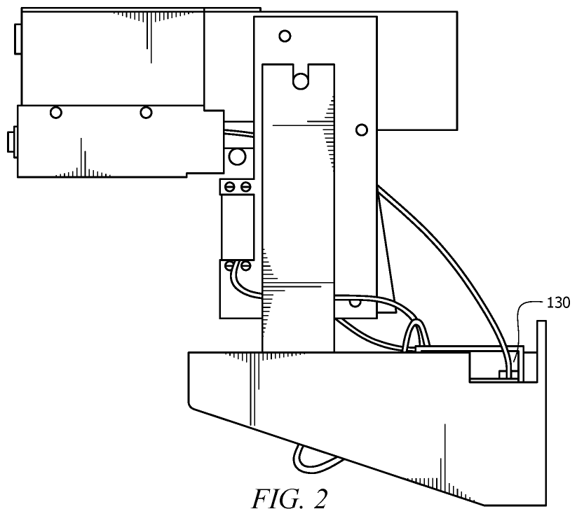

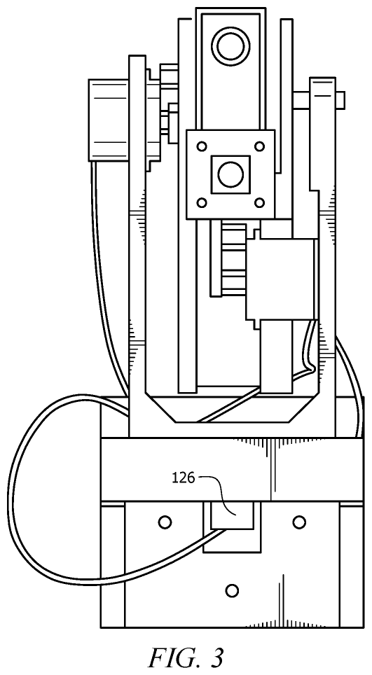

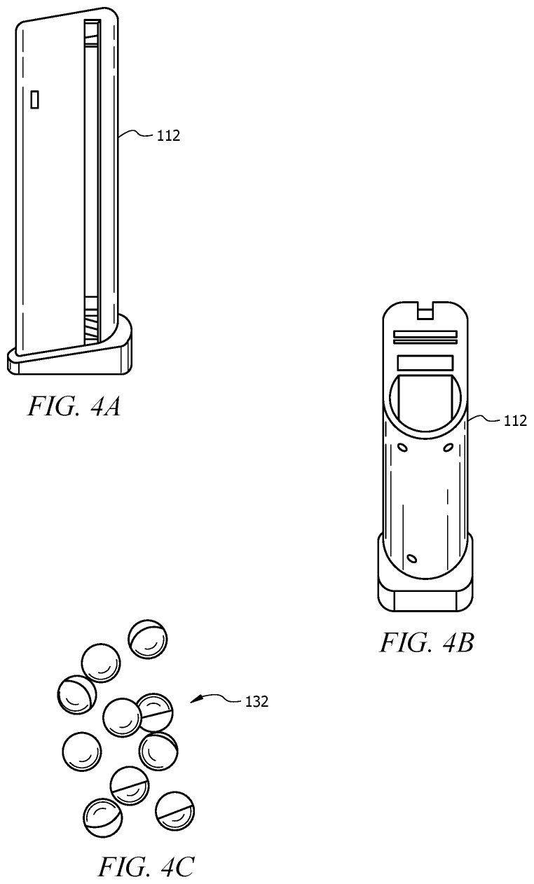

The present disclosure relates to a safety device 100 which may be configured to fire projectiles 132. FIGS. 1-4C illustrate an embodiment of the safety device 100, wherein the safety device 100 includes a firing mechanism 110, a y-axis frame 118, an x-axis frame 124, and a camera 116. The firing mechanism 110 is configured to include a cartridge 112, a first power source 114, and a trigger 134. In various embodiments, the cartridge 112 is a hopper, a magazine, or a drum. The cartridge 112 is configured to hold projectiles 132. Depending on the circumstances, the projectiles 132 may be filled with pepper spray (or liquid, solid, or gaseous tear gas equivalents) or a fire extinguishing substance. Additionally, the cartridge 112 may be adapted to use both pepper spray or fire extinguishing substances according to a user's preference. In such embodiments, the firing mechanism 110 may be equipped with multiple cartridges containing different types of projectiles. In an alternative embodiment, the cartridge 112 is configured to hold a pressurized liquid, such as, but not limited to, pressurized water or a fire extinguishing substance.

The first power source 114 is a compressed gas unit. Depending on the circumstances, the compressed gas unit is pure pressurized carbon dioxide gas (CO2), pure pressurized nitrogen gas (N₂), or pressured air (78% N₂ by volume). Alternatively, the first power source 114 may be a mechanical unit (e.g., spring action mechanism) or a chemical unit (e.g., combustion chamber). The y-axis frame 118 is configured to include a first actuator 120 and a trigger actuator 122. The trigger actuator 122 is configured to engage the trigger 134. In one embodiment, engaging the trigger 134 prompts the first power source 114 to provide power to the firing mechanism and subsequent engagements result in the firing mechanism 110 firing the projectiles 132. In another embodiment, engaging the trigger 134 results in the firing mechanism 110 to fire the projectiles 132. Alternatively, the firing mechanism 110 may be configured with an electrically activated trigger instead of a mechanical trigger 134. An electrically activated trigger comprises a wire from an electrical power source connected to a combustible substance. The combustible substance is adjacently located to a chamber holding a projectile. When a current is passed through the wire to the combustible substance, the combustible substance ignites and propels a projectile. The first actuator 120 is configured to maneuver the safety device 100 about a y-axis. In some embodiments, the safety device 100 is capable of rotating 360 degrees about its y-axis. In an alternative embodiment, the safety device 100 is configured to replace the mechanical trigger engagement (i.e., trigger actuator) with an electrical actuator, wherein the trigger is engaged by an electrical current.

The x-axis frame 124 may be configured to include a second actuator 126, a mounting base 128, and a first control unit 130. The second actuator 126 is configured to maneuver the safety device 100 about an x-axis. In some embodiments, the safety device 100 is capable of rotating 360 degrees about its x-axis. In an alternative embodiment, the safety device does not utilize the y-axis frame and the x-axis frame. Instead, the mounting base 128, the first actuator 120 and the second actuator 126 directly attach to the firing mechanism 110. The first control unit 130 comprises a first access point and a second power source. The second power source connected to the well-known power sources such as, but not limited to, residential and commercial power grids, electric generators, and fuel cells. The mounting base 128 is configured to attach the safety device 100 to the surface of a structure.

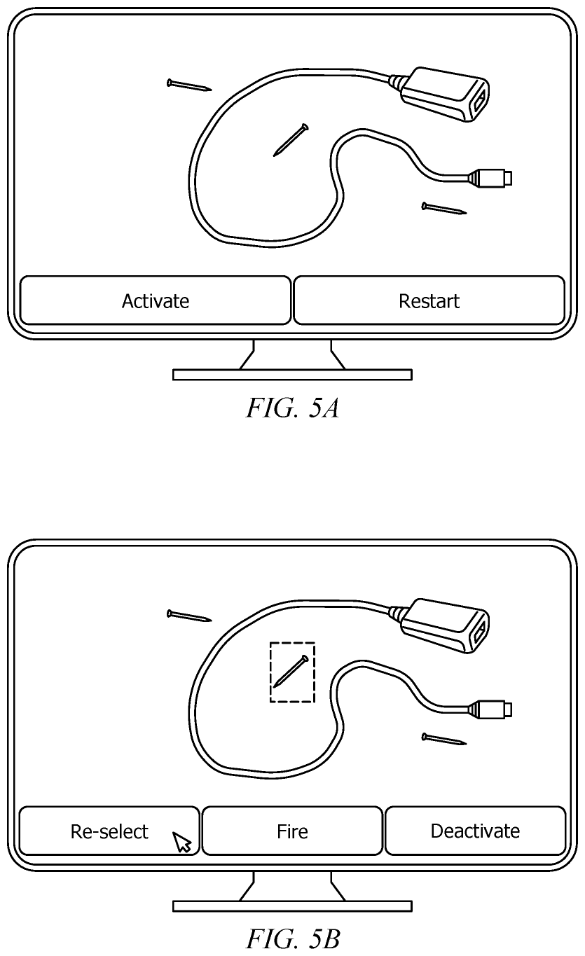

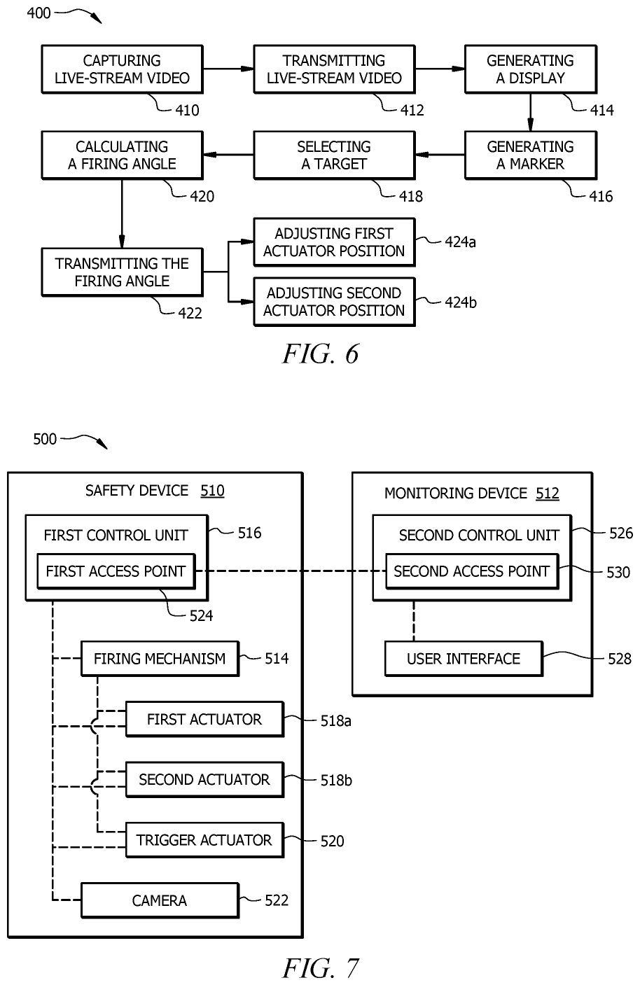

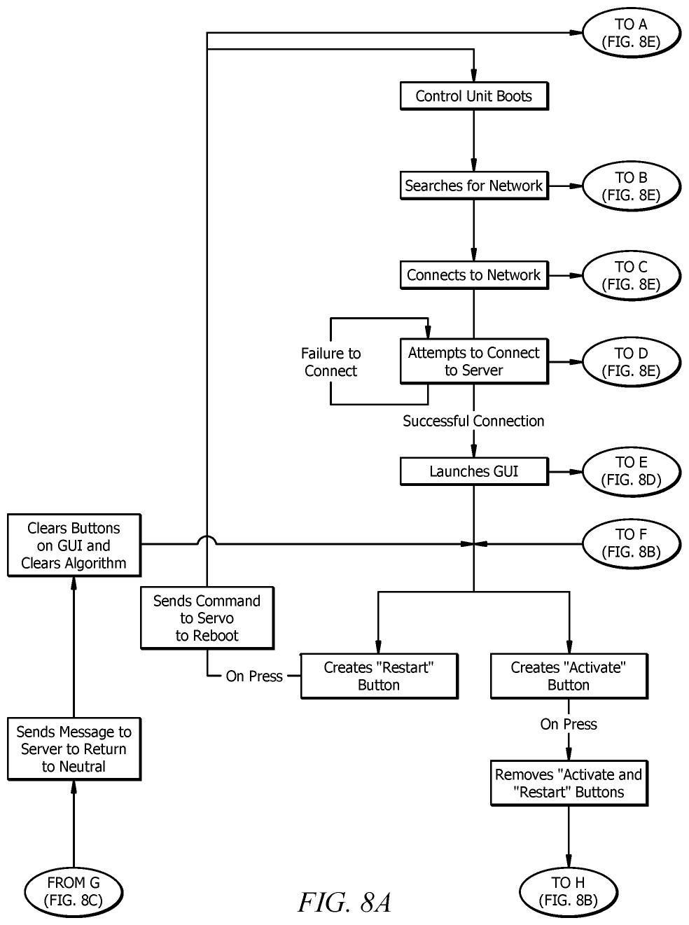

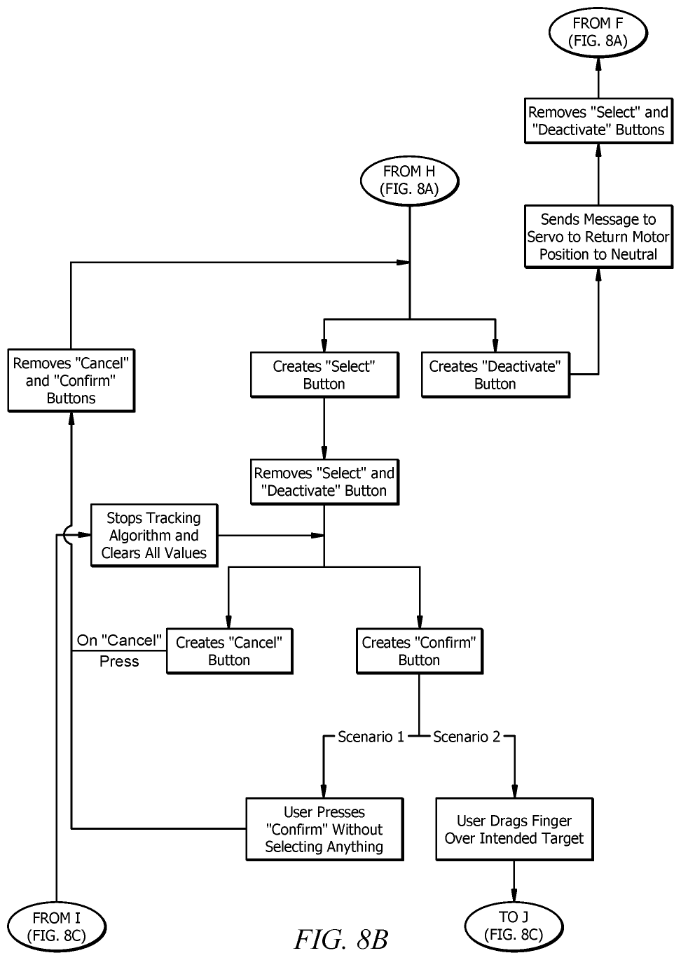

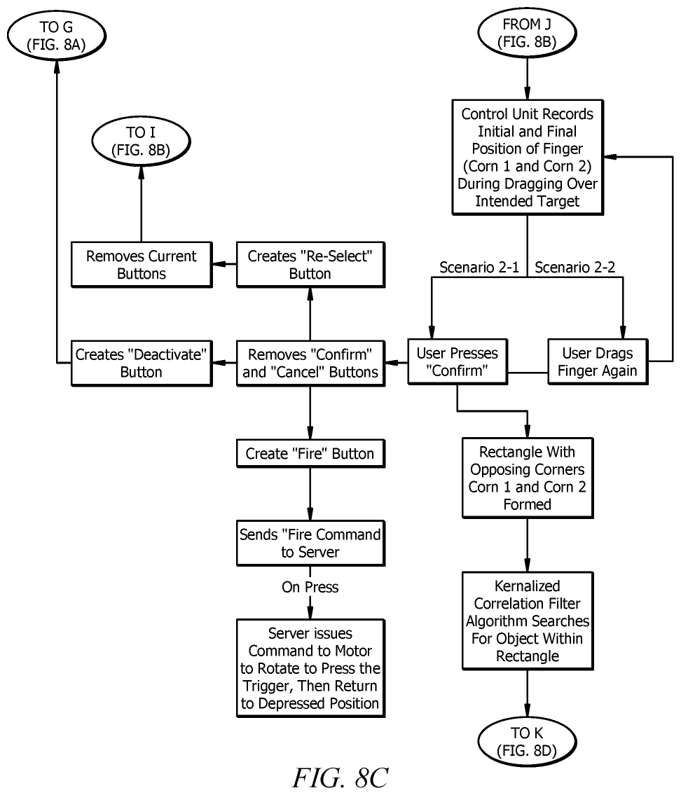

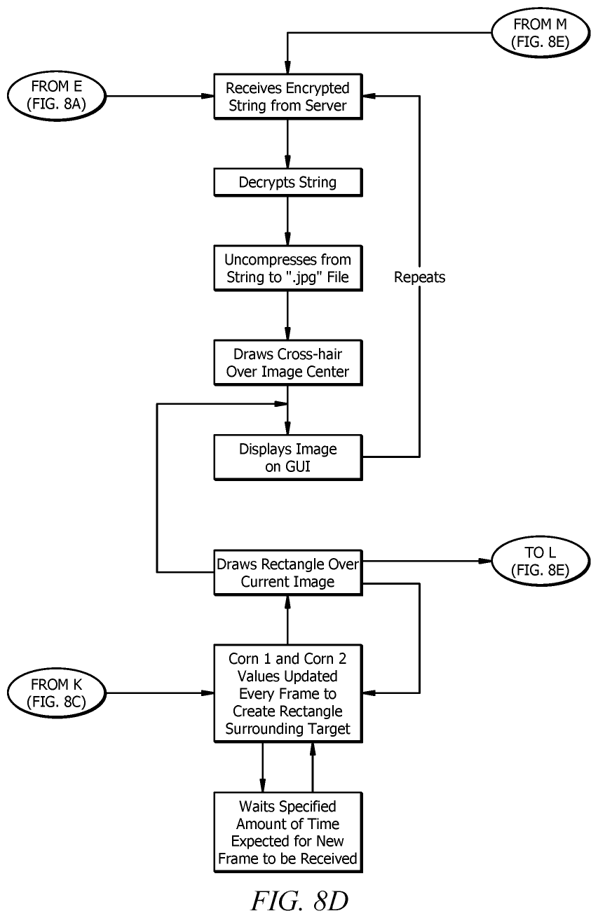

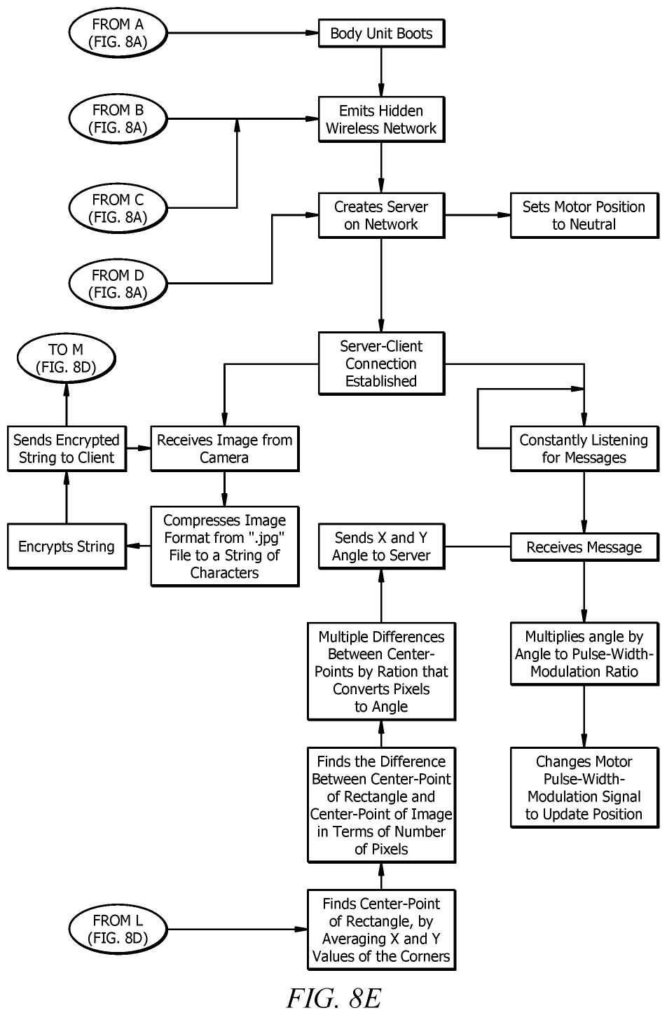

The present disclosure also relates to methods for operating a safety system, as illustrated in FIGS. 6 and 8A-8E. In one embodiment, the method 400 for operating the safety system comprises a variety of steps, beginning by capturing 410 imaging through a safety device. Imaging may comprise photographic imaging or video imaging. The safety device transmits 412 the imaging to a monitoring device. The monitoring device processes the imaging and generates 414 a display on a user interface. The display comprises the imaging and a command box. Additionally, the monitoring device generates 416 a marker within display, wherein the marker corresponds to the location the firing mechanism is aimed at in the imaging. A target in the display is selected 418, wherein the marker is placed on the target. FIGS. 5A and 5B illustrate one embodiment of the user interface.

Once a target is selected, the monitoring device executes an algorithm to calculate 420 a firing coordinate, which corresponds to the location of the target in a given coordinate system. In one embodiment, the algorithm calculates the firing coordinate based on pixels on a display. First, the algorithm generates a rectangle around the target, is defined by two opposing corners (x₁,y₁) and (x₂,y₂). Once the opposing corners are established, the algorithm executes a tracking algorithm. In one embodiment, a Kernelized Correlation Filter is utilized to track the location of the target inside of the rectangle based on metrics known in the art such as, but not limited to, color, size and shape. The center point of the rectangle (rₓ,r_{y}) is calculated by averaging the distance between the two corners. The center point of the target (tₓ,t_{y}) is calculated by dividing the length and width of the target by two, which corresponds to the location of the marker on the display. Next, the algorithm determines the target delta (tₓ−rₓ, t_{y}−r_{y}) by calculating the distance between the center point of the target and the center point of the rectangle. Because the pixels in the imaging correspond to a certain angle (θ) and length (L) along the x-axis, a pixel-to-angle factor (θ/L) provides a correlation between the number of degrees per pixel length. The algorithm multiplies the target delta by the pixel-to-angle factor to calculate angle coordinates (δₓ, δ_{y}). The second control unit transmits 422 the angle coordinates to the first control unit, wherein the first control unit determines the firing coordinates (x_{F},y_{F}). In embodiments utilizing servo motors, the first control unit calculates a pulse-width modulation factor (γ) that corresponds with the range of motion in each actuator. The first control unit determines the firing coordinates by multiplying the angle coordinate by the pulse-width modulation factor. The first control unit transmits the firing coordinates to the first actuator and second actuator, which adjust 424a, 424b their positions accordingly. In other embodiments, the algorithm is adapted to predict the position of the object based on the relationship between historical position and rate of change.

In an alternative embodiment, a first set of commands is generated in the command box in the display. The first set of commands comprising an activate command and a restart command. The restart command restarts the operating systems on the monitoring device, the safety device, or both the monitoring device and the safety device. The activate command prompts a second set of commands comprising a select command and a cancel command. In some embodiments, the activate command operates as a redundancy to increase the safety and reliability of the safety system. The cancel command terminates the process and returns to the first set of commands. After the marker is generated 416, selecting the select command enables the target to be selected 418 and prompting a third set of commands.

The third set of commands comprising a confirm command and an abort command. The abort command terminates the process and returns to the first set of commands. The confirm command prompts the monitoring device to calculate 420 the firing coordinate, wherein the monitoring unit continuously tracks the target. After the first actuator and the second actuator adjust 424a, 424b their positions, a fourth set of commands is generated. The fourth set of commands comprises a re-select command, a fire command, and a deactivate command. The deactivate command terminates the process, returns to the first set of commands, and places the first actuator and the second actuator into a neutral position. The re-select command clears the current target and enables a new target to be selected. The fire command transmits a signal to the safety device, wherein the trigger actuator is engaged and fires the projectiles. The safety device may be configured to utilize the various well-known firing modes in the art such as, but not limited to, semi-automatic, fully-automatic, and burst modes. In additional embodiments, the first fire command operates as a redundancy, engaging the first power source instead of firing a projectile. All subsequent fire commands result in projectiles being fired. The safety device may also be configured to operate in a warning mode, which fires the projectiles around the target. In another embodiment, the safety device may be configured in a verbal warning mode, which plays a pre-recorded audio message instead of firing a projectile. Alternatively, the safety device may be configured to operate in a monitoring mode, which records the captured events and stores them on the second control unit.

FIG. 7 illustrates an embodiment of the safety system. In one embodiment, the safety system 500 comprises a safety device 510 and a monitoring device 512. The safety device 510 configured to include a firing mechanism 514, a first control unit 516, a first actuator 518a, a second actuator 518b, a trigger actuator 520, and a camera 522. The camera 522 includes digital cameras and infrared cameras, depending on the lighting of the environment. Additionally, the safety device may be configured with alternative sensory equipment, such as weak radar or sound-based devices to detect a target. The first control unit 516 includes a first access point 524. In some embodiments, the first control unit 516 is a server, capable of communicating with multiple control units (e.g., clients). The monitoring device 512 includes a second control unit 526 and a user interface 528. The second control unit 526 is configured to communicate with the user interface 528. In some embodiments, the user interface 528 is a touch screen device. The second control unit 526 includes a second access point 530, wherein the second access point 530 is in two-way communication with the first access point 524. The second control unit may be a variety of processing units such as, but not limited to, desktop computers, laptops, tablets, or mobile devices. In additional embodiments, the second control unit 526 utilizes a mouse and keyboard in the navigation of the user interface.

In some embodiments, the second access point 530 and the first access point 524 may be in direct or wireless communication. Direct communication may include, tethering by data cables such as, for example, USB and ethernet cables. Wireless communication includes any known method of wirelessly transmitting data such as, for example, WiFi, Bluetooth, cellular communication, or radio communication. The first control unit 516 is in communication with the first actuator 518a, the second actuator 518b, the trigger actuator 520, and the camera 522. The camera 522 is configured to transmit imaging to the first control unit 516, wherein the imaging corresponds the location that the firing mechanism 514 is aimed. The first control unit 516 is configured to transmit the imaging to the second control unit 526. The second control unit 526 processes the imaging and generates a display on the user interface 528. The display is configured to include the imaging.

In alternative embodiments, the display further comprises a command box and a marker. The marker is an icon that is placed on an object that is selected as a target. When a target is selected in the display, the second control unit 526 executes a tracking algorithm to track the position of the target. The tracking algorithm calculates angle coordinates for the target that correspond to the target's position. The tracking algorithm continuously calculates the angle coordinates, updating the angle coordinates when the target's position changes. The tracking algorithm must be fine-tuned according to the hardware power in the system, otherwise, processing and mechanical failures will arise.

Additionally, the system must be equipped to take into account delays between signal transmissions and mechanical movement when the target changes positions. The system addresses this issue by calculating the value of frames per second (FPS) in relation to the inverse of total time (β) for the function to be executed and movement to be performed in seconds, as shown here:

FPS≤1/β

Determining the total time (β) requires intensive testing and calculations to ascertain an optimal upper bound value for total time (β) in a given system. Additionally, the transmission of imaging between the first control unit and second control unit requires a time-intensive process, which affects the total time (β) and, in turn, FPS. Imaging transmission requires multiple signal processing steps such as compression, encryption, transmission, and decompression. Accordingly, the most efficient algorithm for imaging transmission requires using multiple programming languages to transmit the imaging in a time frame that results in an optimal total time (β).

The second control unit 526 transmits the angle coordinates to the first control unit 516, wherein the first control unit 516 analyzes the angle coordinates and generates firing coordinates. The first control unit 516 transmits the firing coordinates to the first actuator 518a and the second actuator 518b. The first actuator 518a and the second actuator 518b adjust their position according to the firing coordinates to position the firing mechanism 514 into a firing angle. The firing angle corresponds to the current position of the target. The safety device 510 further comprises a frame, which is mountable on the surface of a structure.

In addition to a safety system configured for target detection by a user, the safety device may be configured to automatically detect movement and alert the monitoring device. The safety device captures imaging of the environment and detects any change in the properties in the captured imaging. Changes in the properties may include for example, any increase or decrease in the brightness of the pixels in the imaging. Additionally, these configurations incorporate a mobile device, such as a phone, to receive notifications in a remote location. The mobile devices have software installed on the device that function in the same manner as the software in the monitoring device.

The safety system may additionally be configured to automatically track and fire upon objects within specified parameters. For example, the system may be programmed with pre-set parameters (e.g., length, width, brightness, rate of position change) that correlate with a human target. Once a human target is detected, the safety system tracks and fires upon the target until the object is no longer in view or another parameter is fulfilled. In some embodiments, the algorithm will track and fire upon the target if the parameters fall within a 95% confidence limit.

Typically, the safety device 510 is mounted onto the interior or exterior of a standing structure, such as, but not limited to, residential or commercial buildings. However, the safety device 510 may be mounted onto the surface of a vehicle, such as an automobile or an aerial vehicle. Non-limiting examples of aerial vehicles include unmanned aerial vehicles (e.g., a drone) airplanes, helicopters, and gliders. Further, the safety system 500 can be configured to operate on the same hardware system as an unmanned aerial vehicle, enabling a user to control both the unmanned aerial vehicle and the safety system 500 with a single control unit. In other embodiments, the frame comprises a y-axis frame and an x-axis frame, which enable the firing mechanism 514 to move in a direction along the y-plane and the x-plane. The y-axis frame comprises the first actuator 518a and the x-axis frame comprises the second actuator 518b and a mounting base. In one embodiment, the first actuator 518a, the second actuator 518b, and the trigger actuator 520 are motors. The motors include electric motors (e.g., axial rotors, servo motors, stepper motors, etc.). Alternatively, the actuators may be any other actuator known in the art such as, but not limited to, stepper motors, or a belt system. In embodiments using motors as actuators, the torque generated by the fast motor rotation creates an unexpectedly disproportionate amount of stress between the mounting base 128 and the mounting structure. The most efficient manner to address this issue was to add additional points of contact between the rotating objects connected to the motors. The additional points of contact increase the amount of friction on the rotating motors, which decreases the rate of rotation.

What is claimed:

1. A safety device for firing projectiles, comprising:
a firing mechanism comprising a cartridge and a first power source, wherein the cartridge comprises projectiles;
a camera;
a y-axis frame comprising a first actuator and a trigger actuator;
an x-axis frame comprising a second actuator and a mounting base, wherein a first control unit is mounted on the mounting base; and
the first control unit comprising a second power source and a first access point, wherein the first control unit is in two-way communication with the first actuator, the second actuator, the trigger actuator, and the camera.

2. The safety device of claim 1, wherein the first actuator is a motor or a belt system.

3. The safety device of claim 1, wherein the second actuator is a motor or a belt system.

4. The safety device of claim 1, wherein the trigger actuator is a motor or a belt system.

5. The safety device of claim 1, wherein the first power source is a compressed gas unit, a mechanical unit, or a chemical unit.

6. A method for operating a safety system, wherein the safety system comprises a safety device and a monitoring device, the safety device comprising a firing mechanism, a first actuator, a second actuator, a trigger actuator, and a camera, the monitoring device comprising a user interface, the method comprising the steps of:
(a) capturing imaging with the camera;
(b) transmitting the imaging from the safety device to the monitoring device;
(c) generating a display on the user interface, wherein the display comprises the imaging;
(d) generating a marker in the display, the marker corresponding to an aim of the firing mechanism;
(e) selecting a target in the display, wherein the marker is placed on the target;
(f) calculating a firing coordinate, wherein the firing coordinate corresponds with a location of the target;
(g) transmitting the firing coordinate to the safety device; and
(h) adjusting a position of the first actuator and the second actuator.

7. The method of claim 6, wherein step (c) a first set of commands is generated, the first set of commands comprising an activate command and a restart command.

8. The method of claim 7, wherein selecting the activate command generates a second set of commands, the second set of commands comprising a select command and a cancel command.

9. The method of claim 8, further comprising the step, between steps (d) and (e) of selecting the select command, wherein a third set of commands is generated, the third set of commands comprising a confirm command and an abort command.

10. The method of claim 6, further comprising the step, between steps (e) and (f) of selecting the confirm command, wherein the monitoring unit tracks a location of the target.

11. The method of claim 6, wherein following step (h) a fourth set of commands is generated, the fourth set of commands comprising a re-select command, a fire command, and a deactivate command.

12. A safety system of monitoring and firing projectiles, the safety system comprising:
a safety device comprising a firing mechanism, a first control unit, a first actuator, a second actuator, a trigger actuator, and a camera, wherein the first control unit comprises a first access point;
the first control unit in communication with the first actuator, the second actuator, the trigger actuator, and the camera;
wherein the camera transmits to the first control unit imaging of a location the firing mechanism is aimed;
a monitoring device comprising a second control unit and a user interface, the second control unit in communication with the user interface;
wherein the second control unit comprises a second access point, the second access point in two-way communication with the first access point;
the first control unit transmitting the imaging to the second control unit, wherein the second control unit generates a display on the user interface, the display comprising the imaging;
selecting a target in the imaging, wherein the second control unit executes a tracking algorithm, the tracking algorithm continuously calculating a firing coordinate, wherein the firing coordinate corresponds to a position of the target; and
transmitting the firing coordinate to the first control unit, wherein the first control unit adjusts the first actuator and the second actuator, the first actuator and the second actuator adjusting a firing angle of the firing mechanism to correspond to the position of the target.

13. The safety system of claim 12, wherein the first control unit and the second control unit are in wireless communication.

14. The safety system of claim 12, wherein the first control unit and the second control unit are in direct communication.

15. The safety system of claim 12, wherein the user interface comprises a touch screen device.

16. The safety system of claim 12, wherein the second control unit generates a marker on the target.

17. The safety system of claim 12, wherein the safety device is mounted to the exterior of a standing structure.

18. The safety system of claim 12, wherein the safety device is mounted to a surface of a drone.
